(19) United States
(12) Patent Application Publication
(10) Pub. No.: US 2004/0116023 A1
(43) Pub. Date: Jun. 17, 2004

(54) Thermal wrap with elastic properties

(76) Inventors: Lei Huang, Duluth, GA (US); Alan Edward Wright, Woodstock, GA (US); Naveen Agarwal, Atlanta, GA (US); Jeffrey Eldon Fish, Dacula, GA (US)

Correspondence Address: KIMBERLY-CLARK WORLDWIDE, INC., 401 NORTH LAKE STREET, NEENAH, WI, 54956

(21) Appl. No.: 10/322,411

(22) Filed: Dec. 17, 2002

(51) Int. Cl. B32B 1/00; B32B 31/00; B32B 5/26

(52) U.S. Cl. 442/328; 442/329; 442/366; 442/381; 442/416; 156/166; 156/160; 156/161; 156/162

(57) ABSTRACT

There is provided an elastic thermal insulating wrap having a insulating skin facing layer and an airflow impeding layer, with elastic strands interposed therebetween. The elastic strands are arranged in a substantially parallel manner and the strands and layers are bonded to produce the wrap laminate.

### BACKGROUND OF THE INVENTION

Thin, low cost, and stretchable thermal body wraps are very useful for thermal therapy products. These wraps should be easily stretched and wrapped around a body part and keep the desired temperature for a desired time. They should be thin and convenient enough to be worn under a suit or jacket without a bulky appearance, and could also provide the benefits of low-level thermal therapy and compression therapy for pain relief, circulation enhancement and injury prevention to meet consumers' needs.

While the existing wraps have performed adequately, they are not as comfortable to wear as may be desired. In addition, they have been found to be relatively expensive to produce because of the materials needed to make them. There remains a need for an elastic thermal wrap that is more comfortable for a wearer and which has excellent thermal insulating properties.

### SUMMARY OF THE INVENTION

In response to the discussed difficulties and problems encountered in the prior art, a new thermal wrap with elastic properties has been developed. The wrap is made of a relatively thicker insulating layer having a high capacity for holding air, bonded to a relatively thinner layer made from meltblown fabric, film or such other material as may serve to impede airflow through the laminate. Elasticity is provided by a layer of elastic strands interposed between the insulating and airflow impeding layers and is arranged in a substantially parallel manner. The structure is desirably held together by the use of an adhesive or tacky meltblown fibers. The wrap is desirably inexpensive to produce and disposable.

### BRIEF DESCRIPTION OF THE DRAWINGS

FIG. 1A is a drawing of the material of the invention and FIG. 1B is a schematic drawing of a process of making the material of the invention

FIG. 2 is a drawing of the apparatus for thermal testing according to the Thermal Therapy Temperature Profile Test.

FIG. 3 is a schematic drawing of the Kawabata Evaluation System (KES) Thermo Labo II equipment which was used to directly measure heat loss through a sample.

FIG. 4 is a graph of the thermal insulation ability of a number of materials according to the Kawabata Thermal Insulation Performance Test.

FIG. 5 is a graphical representation of results of testing the material of Example 1 according to the Thermal Therapy Temperature Profile Test.

FIG. 6 is a graphical representation of results of testing the material of Example 2 according to the Thermal Therapy Temperature Profile Test.

FIG. 7 is a graphical representation of results of testing the material of Comparative Example 1 according to the Thermal Therapy Temperature Profile Test.

FIG. 8 is a graphical representation of results of testing the material of Comparative Example 2 according to the Thermal Therapy Temperature Profile Test.

FIG. 9 is a graphical representation of results of testing a self adhesive bandage from the Johnson & Johnson company according to the Thermal Therapy Temperature Profile Test.

FIG. 10 is a graphical representations of results of testing a 4.4 ounce per square yard (149 grams per square meter or gsm) cotton knit according to the Thermal Therapy Temperature Profile Test.

FIG. 11 is a graphical representation of results of testing the non-stretchable portions of a THERMA-CARE® wrap from the Procter & Gamble Company according to the Thermal Therapy Temperature Profile Test.

### DETAILED DESCRIPTION OF THE INVENTION

The present invention is a thermal wrap having elastic properties such that it is useful in thermal therapy on limbs and other body parts. It may also be used in veterinary applications and in general insulating applications where a wrap that will conform to a shape is needed.

The wrap has an insulating layer that presents a padded surface toward the skin of the wearer, a thinner, airflow impeding layer on the side away from the skin and elastic strands therebetween.

As alluded to above, the elastic wrap of this invention can conform to a wide variety of shapes. It may be used on large limbs like the upper leg as well as smaller objects like water pipes, to help protect them from freezing. Veterinary uses include the wrapping of limbs of animals for support in the case of injury.

The insulating layer is one that is soft to the touch and reduces or eliminates the occurrence of red-marking and/or irritation if brought into contact with a person's skin. This insulating layer also serves to maintain warmth near the skin. The insulating layer is inherently inextensible except when it is gathered in a laminate.

The insulating layer may be made according to various nonwoven processes such as a web made by the meltblowing, coforming, spunbonding, bonded carded web and other processes. See for example, U.S. Pat. Nos. 3,849,241, 5,382,400, 4,340,563 and 3,692,618. One suitable material is bonded carded web which may be made from polyolefin fibers or of rayon or polyethylene terephathalate (PET) fibers or mixtures thereof. Yet another material for the insulating layer is a conjugate or bicomponent fiber layer, desirably including rayon, PET and/or polyolefins. One desirable type of bicomponent fiber is a polypropylene/polyethylene, sheath/core fiber. See, for example, U.S. Pat. Nos. 4,795,668, 5,540,992 and 5,336,552. Bicomponent fibers are commercially available from KoSA Inc. (formerly Trevira Inc. and formerly Hoechst-Celanese), of Salisbury, N.C. 28145-0004 under the designation T-255 and T-256, though many suitable bicomponent fibers are known to those skilled in the art, and are made by many manufacturers such as the Chisso Corporation of Japan and Fibervisions LLC of Wilmington, Del.

In one embodiment, the insulating layer may be made from meltblown fibers that may be made according to methods known in the art from various olefins and olefin co-polymers like polyethylene, polypropylene, polybutylene etc. Meltblown fibers may also be made from elastic polymers.

In another embodiment the insulating layer may be a coform layer or meltblown fibers as discussed above, with pulp. The coform process is one in which at least one meltblown diehead is arranged near a chute through which other materials are added to the web while it is forming. Such other materials may be pulp, superabsorbent particles, natural and regenerated fibers (for example, cotton or rayon fibers) and/or synthetic polymers (for example, polypropylene or polyester) fibers, for example, where the fibers may be of staple length. Coform processes are shown in commonly assigned U.S. Pat. Nos. 4,818,464 and 4,100,324. Webs produced by the coform process are generally referred to as coform materials.

If pulp is used in the coform process it may be standard softwood fluffing grade such as CR-1654 (US Alliance Pulp Mills, Coosa, Ala.). Pulp may be modified in order to enhance the inherent characteristics of the fibers and their processability. Curl may be imparted to the fibers by methods including chemical treatment or mechanical twisting. Curl is typically imparted before crosslinking or stiffening. Pulps may be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Some of these agents are less desirable than others due to environmental and health concerns. Pulp may also be stiffened by the use of heat or caustic treatments such as mercerization. Examples of these types of fibers include NHB416 which is a chemically crosslinked southern softwood pulp fibers which enhances wet modulus, available from the Weyerhaeuser Corporation of Tacoma, Wash. Other useful pulps are debonded pulp (CF405) and non-debonded pulp (NB416) also from Weyerhaeuser. HPZ3 from Buckeye Technologies (Memphis, Tenn.) has a chemical treatment that sets in a curl and twist, in addition to imparting added dry and wet stiffness and resilience to the fiber. Another suitable pulp is Buckeye HP2 pulp and still another is IP Supersoft from International Paper Corporation. Suitable rayon fibers are 1.5 denier Merge 18453 fibers from Acordis Cellulose Fibers Incorporated of Axis, Alabama.

Another suitable insulating layer material is a “tuft-textured” coform material made of meltblown fibers and pulp according to U.S. Pat. No. 4,741,941. This material is formed onto a forming wire with an elevated below wire vacuum, thus forming resilient tufts in the material. The resulting material has a high bulk value and a soft surface texture. Tuft-textured coform has overlapping thermoplastic fibers or filaments defining an array of hollow or filled projections extending out of the material and separated by planar land area in a plane taken along a line parallel to the material, ignoring the projections. The material is characterized by at least a 5 degree or higher average degree of fiber or filament alignment in the projections than in the land area. Other suitable three-dimensional forming techniques would be suitable as well.

Coform materials for the practice of this invention desirably have from 20 to 80 weight percent meltblown fiber, with the balance pulp. The weight ratio of the meltblown and pulp may, for example, be between 20/80 and 80/20. More desirably a ratio of between a 30/70 and 70/30 may be used, or still more desirably a ratio of between 40/60 and 60/40 may be used.

Other suitable insulating materials that are three-dimensional may also be used. These include textured airlaid webs which may be made by a process which includes the steps of combining fibrous materials with a gas. The gas and fiber mixture is directed onto a moving conveyer to form a non-woven web. The web is contacted with a fabric having a three-dimensional surface under sufficient force to cause the web to conform to the three-dimensional surface and thereby form a textured surface on the web. The textured surface includes a repeating pattern of peak areas and valley areas that correspond to the three-dimensional pattern present on the fabric. After the textured surface is formed, the airlaid web is bonded together by thermal bonding or through the use of an adhesive. Examples of airlaid processes include those described in U.S. Pat. Nos. 4,640,810, 4,494,278, 5,527,171 and 4,375,448.

It is possible that the insulating layer include additives for various purposes. These additives include active for odor control, skin health, wettability for perspiration absorption and so forth. Additives of these types are well known in the art and may optionally be added to the innermost layer to contact the skin and produce desired effects in an effective amount.

Various materials for the insulating layer were tested for thickness and basis weight and the results given in Table 1 below. These include, in order in Table 1, the insulating layers from Examples 1-6 below and a 62 gsm airlaid material made with 83 weight percent CF405 pulp and 17 weight percent latex binder.

TABLE 1

| Sample | Thickness (mm) | Basis weight (gsm) |
|---|---|---|
| 1 | 1.98 | 70 |
| 2 | 1.16 | 50 |
| 3 | 1.36 | 70 |
| 4 | 1.10 | 70 |
| 5 | 1.35 | 40 |
| 6 | 1.15 | 50 |
| 7 | 1.10 | 62 |

It is desirable in the practice of this invention that the insulating layer have a thickness between about 1 and 2 mm, more desirably between 1.3 and 2 mm and most desirably between 1.6 and 2 mm. The basis weight is desirably between 40 and 100 gsm, more desirably between 50 and 80 gsm and most desirably about 70 gsm. The combination of basis weight and thickness serves to define an open, bulky structure which has a large amount of void space and therefore insulates well.

The airflow impeding layer serves to reduce air flow through the structure in order to reduce convective heat loss and may also provide stretch recovery. Alternatively, an inelastic but stretchable layer may be used. The airflow impeding layer of the wrap may be a meltblown, film or other similar material. The airflow impeding layer may also be a laminate of, for example, meltblown layers and spunbond layers. Desirably, a laminate of a meltblown layer and a spunbond layer where the spunbond layer is on the outermost side of the laminate will provide greater abrasion protection to the wrap and protect the meltblown layer. The spunbond layer could be made from bicomponent fibers or monocomponent fibers.

Suitable polymers for the airflow impeding layer include polyolefins, polyamides, polyesters, polyetheresters and the like. One commercial example of a suitable polypropylene for meltblowing is known as PF015 from the Basell Polyolefins Company. Numerous other commercial meltblowing polymers are available from suppliers such as Shell Chemical Co., Exxon-Mobil, BASF and Chisso Chemical Co.

The airflow impeding layer desirably has a thickness of from a positive amount to less than 0.5 mm and more desirably less than 0.4 mm, most desirably about 0.3 mm. The rate of airflow through the thin airflow impeding layer should be sufficiently low as to help maintain the heat within the wrap. Airflow for this layer, as measured by Frazier permeability testing, is generally above 15250 liters per square meter per minute or LMM (50 cubic feet per minute per square foot of material or CFM) or 22860 LMM (75 CFM) and should be below 38100 LMM (125 CFM) desirably less than 30480 LMM (100 CFM) and more desirably less than 27432 LLM (90 CFM).

The elastic layer may be made of oriented stretchable strands of a material like, for example, LYCRA® polymer, that may be bonded to the non-elastic layer to produce a uni-directionally elastic layer. LYCRA®) polymer fibers are commercially available from E.l. duPont of Wilmington, Del. LYCRA® fibers are available in many grades and sizes such as grades 470 and 940, which refers to the decitex of the fiber. The stands may be present in the wrap of the invention in an amount between about 2 and 64 strands per cm (5 to 25 strands per inch) of width, more desirably about 4 per cm (10 strands per inch) and arranged in a substantially parallel manner.

By way of example and not limitation, commercial elastomeric polymers suitable for use in the elastic layer of this invention are, for example, those known as KRATON® block copolymers which are available from Kraton Polymers Inc., of Houston, Tex., in several different formulations, a number of which are identified in U.S. Pat. Nos. 4,663,220, 4,323,534, 4,834,738, 5,093,422 and 5,304,599. Other exemplary elastomeric materials which may be used include polyurethane elastomeric materials such as, for example, those available under the trademark ESTANE® from B.F. Goodrich & Co. or MORTHANE® from Morton Thiokol Corp., polyamide elastomeric materials under the trademark PEBAX® from the Rilsan Company, polyester elastomeric materials such as, for example, those available under the trade designation HYTREL® from E.l. duPont De Nemours & Company, and those known as ARNITEL®, available from DSM of Sittard, Holland. Other suitable materials include, but are not limited to, polyester block amide copolymers, copolyetheresters, and polymers having a Mw/Mn of 4 or less, produced according to the metallocene process.

In order to be suitable for use in the elastic layer, the fibers or strands, upon application of a tensioning or elongating force, are stretchable and elongatable by at least about 50 percent, i.e., to a stretched, elongated length which is at least about 140 percent of its relaxed unstretched length. After being so stretched, the fibers or strands will recover to at least within 10 percent of its relaxed, unstretched length upon release of the stretching or elongating force, desirably within 5.

Good elastic performance of a wrap will allow the wrap to be used to maintain pressure on a limb to, for example, reduce swelling after an injury. An elastic wrap may also be used to support a joint during exercise or movement so that injury does not occur or is less severe if it does occur. When used in conjunction with a heat source, the elastic thermal wrap of this invention should not sag away from the limb. This is important since the wrap may be removed a number of times for inspection of the limb or replacement of the heat source. The wrap should maintain its elasticity for a substantial amount of time and at elevated temperatures.

The layers are desirably held together by an adhesive that optionally is a hot-melt adhesive, added to the materials in an effective amount by conventional means, such as ink jetting and spraying. The exact amount of adhesive will vary depending on the materials used but will generally be between about 2 and 10 gsm, more desirably between 3 and 7 gsm and most desirably between 4 and 6 gsm. Exemplary adhesives are available from Findley Adhesive Company, a division of Bostik Findley, of Wauwatosa, Wis. Suitable Findley adhesives include those designated H2096 and H2025a.

The layers may alternatively be held together by meltblown fibers which are tacky. The fibers may have some tackiness when formed or, optionally, may have added to them a compatible tackifying resin. See, for example, U.S. Pat. No. 4,787,699. Any tackifier may be used that is compatible with the meltblown polymer and that can withstand the processing temperatures and pressures. Hydrogenated hydrocarbon resins are generally desired as tackifying resins because of their relatively better temperature stability. Tackifiers such as those in the REGALREZ® (from Hercules Inc.) and ARKON® (from Arakawa Chem. USA Inc.) series are commercial examples of hydrogenated hydrocarbons while ZONATAK® 501 tackifier is an example of a terpene hydrocarbon.

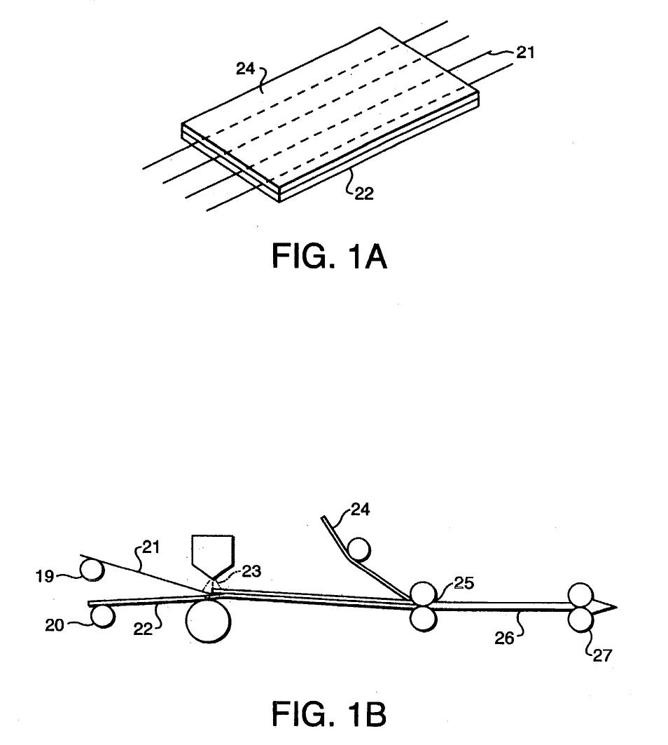

FIG. 1A is a drawing of the wrap of the invention. In FIG. 1A an insulating material 22 is the lowermost layer and strands 21 are interposed between the insulating material 22 and an airflow impeding layer 24.

The materials of the invention may be made according to the process illustrated in FIG. 1B, which shows a method of making a three layer laminate using elastic strands 21. An insulating material 22 such as a coform or bonded carded web material is unwound from a supply roll 20 and the strands 21 are unwound from a supply roll 19. The strands 21 are joined to the insulating material 22 using an adhesive 23 which is generally sprayed onto the insulating layer 22 at an effective add-on amount. The thin airflow impeding layer 24 is then added adjacent the strands 21 and the strands 21 and layers 22, 24 together passed through a nip 25 to encourage intimate contact. The nip 25 also provides the drawing force necessary to stretch the strands 21. After the nip 25, the newly formed laminate 26 passes through a winder 27 which allows the laminate 26 to relax. The speed of the laminate 26 as it passes through the nip 25 relative to the speed of the elastic strands 21 as they come off the supply roll 19 defines a stretching ratio. The ratio of finished laminate speed to the speed of the insulating layer 22 as it comes off the supply roll 20 before addition of elastic strands 21 defines a collection rate. Other suitable methods of making the laminate of this invention include neck bonding wherein an elastic member is bonded to a non-elastic member while only the non-elastic member is extended or necked so as to reduce its dimension in the direction orthogonal to the extension, see, for example, U.S. Pat. Nos. 5,226,992, 4,981,747, 4,965,122, 5,336,545 and 5,514,470, and stretch bonding, wherein an elastic member is bonded to another member while only the elastic member is extended at least about 25 percent of its relaxed length. See, for example, U.S. Pat. Nos. 4,720,415, 4,657,802, 4,652,487 and 4,655,760. It is desirable that, if point bonding is used, the elastic strands not be bonded in a manner that will prevent them from stretching.

The laminate is generally between 3 and 5 mm thick, or more desirably between 3.5 and 4.5 mm thick and most desirably about 4 mm thick, when relaxed. The basis weight of the laminate is usually between 30 and 100 grams per square meter (gsm), more desirably between 40 and 80 gsm and most desirably about 70 gsm. This combination of properties along with the proper choice of raw materials results in a laminate which is skin friendly and has good insulation properties.

Thermal Properties:

The thermal performance of a wrap is an important reason for its use. Good thermal insulating properties allow the treatment of limbs and the like for extended periods of time. A thermal wrap that retains warmth for a longer period will allow less disturbance of an injured limb by requiring fewer bandage changes to renew the heating source. An efficient thermal wrap will also require less material for use as the heat source, thereby taking less space and being less expensive than a larger heat source.

A number of exemplary materials were made and tested for heat retention in conditions that simulated their use on human skin. These were compared to laminates made with commercially available materials. The test method and descriptions of the materials follow.

Test Methods

Thermal Therapy Temperature Profile Test: This test measures the temperature of the skin facing side of a wrap and the away-from-the-skin facing side.

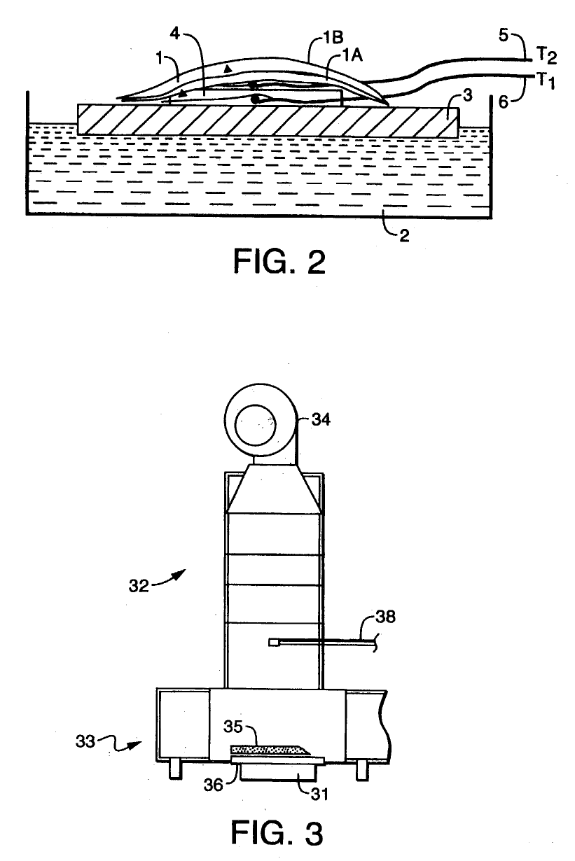

The sample 1 material to be tested is placed in the apparatus of FIG. 2. The test sample 1 should be 15 cm by 15 cm in size and have only a single thickness. The sample 1 as shown in FIG. 2 has a insulating, skin facing layer 1A and thin airflow impeding layer 1B. The test apparatus 10 has a circulating water bath 2 maintained at 35° C. (the approximate human skin temperature) upon which rests a metal plate 3. The metal plate 3 provides a surface for the sample 1 as well as providing an even heating surface. The metal plate 3 is 25 cm by 25 cm. A packet 4 of iron powder is placed upon the metal plate 3 and the sample 1 placed over the packet 4. Thermocouples are placed above 5 and below 6 the packet 4.

The iron powder reacts with air to release heat. In this test, a single Grabber MYCOAL® Mini-Mini Hand Warmer Iron Powder Pocket containing 39.5 grams of iron powder is used for each test. This iron powder hand warmer is commercially available from the Grabber Performance Group of Grand Rapids, Mich. As the iron powder in the pocket reacts with air and releases heat, the temperature of the thermocouples is recorded. The temperature at the thermocouple below 6 the iron powder is recorded as T1 and the temperature at the thermocouple above 5 the packet 4 is recorded as T2.

Kawabata Thermal Insulation Performance Test: This test simulates the amount of heat transferred from the skin through a sample to the outside environment by conduction, radiation, and convection mechanisms.

The Kawabata Evaluation System (KES) Thermo Labo II equipment as shown schematically in FIG. 3 was used to directly measure heat loss in watts. The Thermo Labo II apparatus is available from Kato Tech Co. Ltd, of Kyoto, Japan as model KES-F7 Thermo Labo II type.

Thermal Insulation (Clo) and Thermal Insulation Thickness Efficiency (Clo/Thickness) are calculated from the heat loss data. Three repetitions for each sample were conducted and the average was taken.

The KES Thermo Labo II equipment has a hot plate 31 measuring 10 cm×10 cm at the bottom of a vertical wind sub-chamber 32 which measures 78.2 cm in height by 15.2 cm diameter. There is a horizontal wind sub-chamber 33 measuring 31.75 cm long by 45.7 cm wide by 12.7 cm high to provide precise control of air velocity during testing. The air velocity is maintained at 55 ±3 m/sec in the vertical wind sub-chamber 32 by a fan 34. The heated hot plate 31 is maintained at 35.0° C. to simulate the temperature of human skin. The sample 35 is larger than the hot plate and is recommended to be 22 cm×22 cm. The sample 35 is mounted into a sample frame 36 using double coated adhesive tape or equivalent means. In these tests, the edges of the sample frame 36 were sealed using 3 inches (7.6 cm) wide masking tape.

During testing, the sample 35 directly contacts the hot plate 31 and the ambient 38 and hot plate temperatures are monitored. The base readings taken from the instrument are in Watts. Heat Transfer Rate from the plate through the sample is determined in W/m²° C. The calculations used to calculate Heat Transfer Rate, Thermal Insulation (Clo), and Thermal Insulation Thickness Efficiency (Clo/Thickness) are as follows.

Heat Transfer Rate(in W/m²° C.)=W/[S*(Ts−Ta)]

Thermal Insulation, Clo in (m²° C./W)=(1/Heat Transfer Rate)/0.155

Thermal Insulation Thickness Efficiency (Clo/mm)=Thermal Insulation/Thickness in mm

Where:

W=Heat Consumption in Watts

S=Area of hot plate=0.01 m²

Ts=temperature of hot plate surface (35° C.)

Ta=temperature of the ambient air (22.0° C.)

Frazier Permeability: A measure of the permeability of a fabric or web to air is the Frazier Permeability which is performed according to Federal Test Standard 191A, Method 5450 dated Jul. 20, 1978, and is reported as an average of 3 sample readings. Frazier Permeability measures the air flow rate through a web in cubic feet of air per square foot of web per minute or CFM. Convert CFM to liters per square meter per minute (LMM) by multiplying CFM by 304.8.

Thickness: The thickness of samples was measured using a 3-inch (7.6 cm) acrylic platen thickness tester at 0.05 psi (351.5 kg/M²) and 5 inch (7.6 cm) square sample. Five repetitions for each sample were conducted and the average was taken.

Thermal Therapy Temperature Profile Test Results:

A number of examples of laminates according to the invention are described below. Many were tested according to the Thermal Therapy Temperature Profile Test. In addition, a number of comparative examples were also tested and are described below.

### EXAMPLE 1

This material has a 70 gsm highly textured coform layer made from a 40/60 weight percent blend of meltblown Basell PF015 polypropylene and CF405 pulp, a layer of LYCRA® 470 thread at 4 threads per cm of width, and a layer of 25.4 gsm (0.75 osy) meltblown polypropylene fibers. By “highly textured” is meant that the layer has tufts of about 0.64 cm (0.25 inch). The layers were laminated together using adhesive bonding with adhesive H2025 at a 5 gsm add on rate, using a 9 inch (22.9 cm) spray pattern and 20 psi (1.41 kg/cm²) nip pressure, a 3× stretching ratio, a feed rate of 100 ft/min (30.5 m/min) and a collection rate (ratio of finished laminate speed to the speed of the first layer before addition of elastic strands) of 55 percent.

### EXAMPLE 2

This material is has a 50 gsm through-air bonded carded web layer made from a 40/60 weight percent blend of polypropylene/polyethylene, sheath/core bicomponent spunbond fiber and Rayon fiber, a layer of LYCRA® 470 thread at 4 threads per cm of width and a layer of 25.4 gsm meltblown polypropylene fibers. The layers were laminated together and collected in the same manner as in Example 1.

### EXAMPLE 3

This material is has a 70 gsm medium textured coform layer made from a 40/60 weight percent blend of meltblown Basell PF015 polypropylene and CF405 pulp, a layer of LYCRA® 470 thread at 4 threads per cm of width and a layer of 25.4 gsm meltblown polypropylene fibers. By “medium textured” is meant that the layer has tufts of about 0.32 cm (0.125 inch). The layers were laminated together and collected in the same manner as in Example 1.

### EXAMPLE 4

This material is has a 70 gsm flat coform layer made from a 35/65 weight percent blend of meltblown Basell PF015 polypropylene and CF405 pulp, a layer of LYCRA® 470 thread at 4 threads per cm of width and a layer of 25.4 gsm meltblown polypropylene fibers. The layers were laminated together and collected in the same manner as in Example 1.

### EXAMPLE 5

This material is has a 40 gsm medium textured coform layer made from a 40/60 weight percent blend of meltblown Basell PF015 polypropylene and CF405 pulp, a layer of LYCRA® 470 thread at 4 threads per cm of width and a layer of 25.4 gsm meltblown polypropylene fibers. The layers were laminated together and collected in the same manner as in Example 1.

### EXAMPLE 6

This material is has a 50 gsm through-air bonded carded web layer made from a 40/60 weight percent blend of polypropylene/polyethylene, sheath/core bicomponent spunbond fiber and 2-3 denier per foot (dpf) PET fiber, a layer of LYCRA® 470 thread at 4 threads per cm of width and a layer of 25.4 gsm meltblown polypropylene fibers. The layers were laminated together and collected in the same manner as in Example 1.

### COMPARATIVE EXAMPLE 1

This material has a 40 gsm Type C THINSULATE® layer, a layer of LYCRA® 470 thread at 4 threads per cm of width and a layer of 25.4 gsm meltblown polypropylene fibers. The layers were laminated together and collected in the same manner as in Example 1.

### COMPARATIVE EXAMPLE 2

This material has a 40 gsm Type I THINSULATE®D layer, a layer of LYCRA® 470 thread at 4 threads per cm of width and a layer of 25.4 gsm meltblown polypropylene fibers. The layers were laminated together and collected in the same manner as in Example 1.

### COMPARATIVE EXAMPLE 3

This material is available from the Johnson & Johnson Consumer Companies, Inc. as COACH® brand sports tapes and wraps. It is a self adhesive bandage.

### COMPARATIVE EXAMPLE 4

This material is a 4.4 osy (149 gsm) knit cotton fabric.

### COMPARATIVE EXAMPLE 5

This material is a commercially available nonwoven fabric sold under the trade name THERMA-CARE by the Procter and Gamble Company.

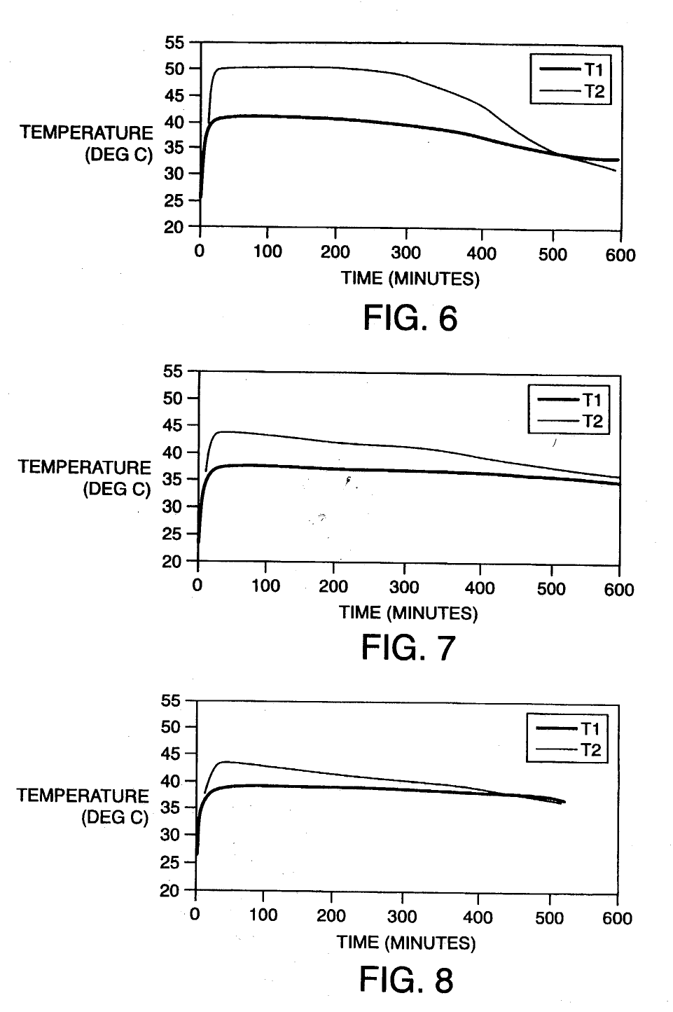

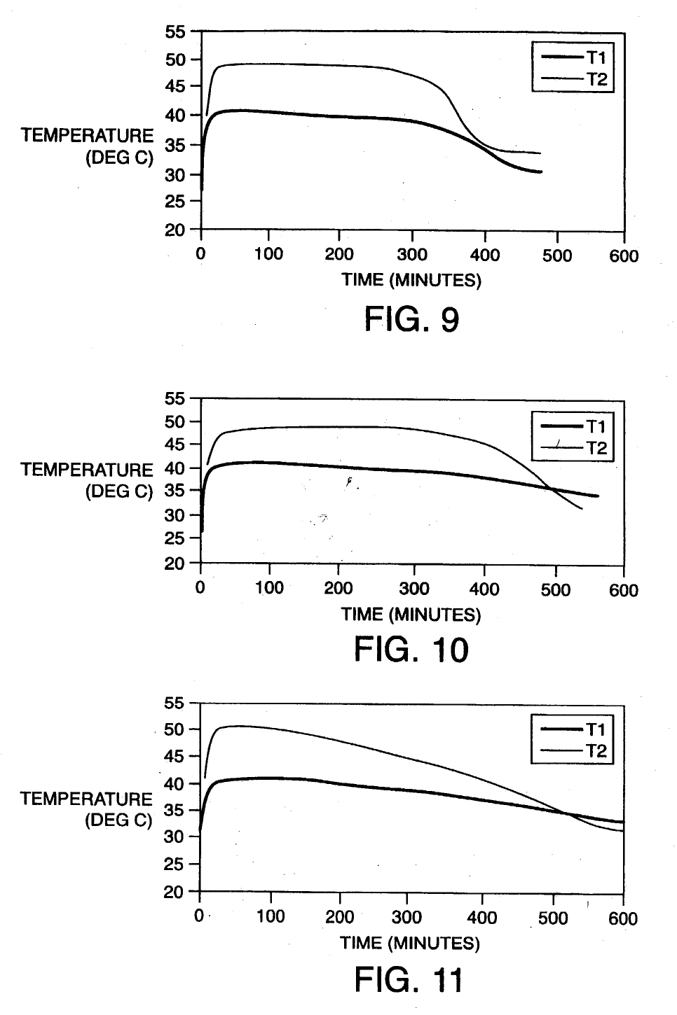

The results of the testing according to the Thermal Therapy Temperature Profile Test above for Examples 1 and 2 and Comparative Examples 1-5 may be seen in FIGS. 5-11 respectively. The Figures graph T1 and T2 in ° C. on the Y (vertical) axis versus time in minutes on the X (horizontal) axis. As can be seen from the graphs, T1 starts out at about 40° C. and slowly deteriorates as the reactants are depleted. T2, the temperature above the iron powder packet, increases beyond 40° C. because of the insulating properties of the test sample.

Two variables are important in judging the efficacy of thermal wraps; the differential temperature (T2-T1) and the time period that the differential is greater than zero. If the differential temperature is great, the insulating layer is retaining heat in the wrap, thus providing more heat to the body. If the differential temperature is low, heat is escaping from the wrap at about the same rate at which it is being generated, thus providing less heat to the body.

The differential temperature is clearly visible from each graph and, since the temperature scale on the graphs is the same, it's clear that the gap between the T2 and T1 temperatures is greater in the Example materials than it is in the Comparative Examples, indicating greater insulating ability. In the same manner, the time at relatively high temperature may be seen from the graphs as well. The Example materials maintain a relatively large gap or differential between T2 and T1 until nearly 450 minutes or seven and a half hours, from the starting time. Comparative Examples 1 and 2 have no or almost no gap between T2 and T1 at 450 minutes. Comparative Example 1 is the better case and, while it does have a differential temperature, it is so small as to almost be insignificant. The other Comparative Examples perform somewhat better than Comparative Examples 1 and 2. The materials of this invention clearly provide greater insulation value than the comparative materials when evaluated according to the Thermal Therapy Temperature Profile Test.

Kawabata Thermal Insulation Performance Test Results:

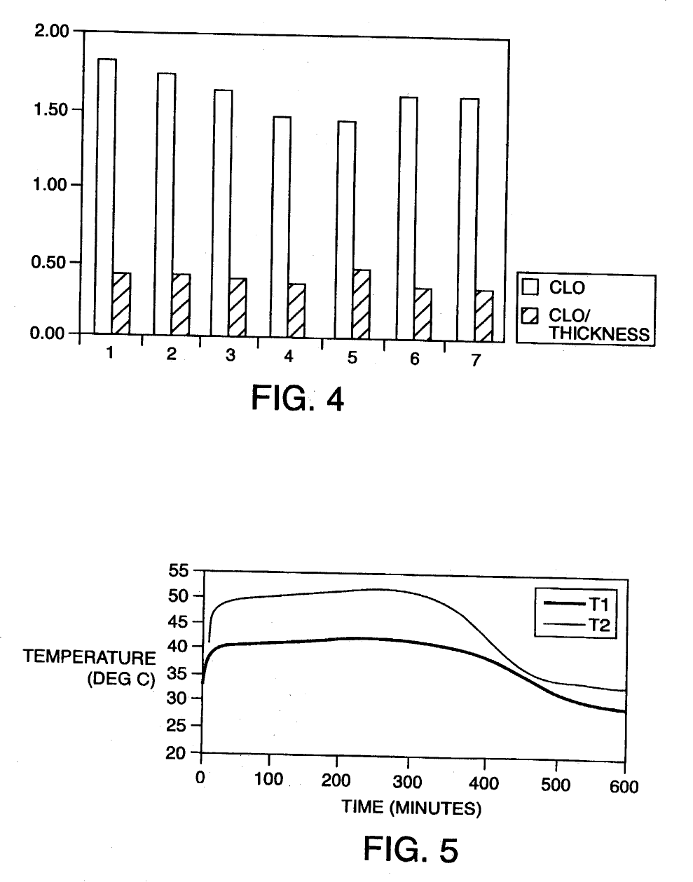

A number of laminates were evaluated according to the Kawabata Thermal Insulation Performance Test using the Kawabata testing machine. The results of this testing are given in graphical form in FIG. 4. The vertical axis indicates the Clo in (m²° C./W) and Clo/mm on a scale of 0 to 2.0 as calculated according to the above methods. The horizontal axis indicates the sample where sample 1 is the laminate of Comparative Example 1, sample 2 is the laminate of Comparative Example 2, sample 3 is the laminate of Example 1, sample 4 is the laminate of example 4, sample 5 is the laminate of Example 5, sample 6 is the laminate of Example 2 and sample 7 is the laminate of Example 6 above. The results are shown below in Table 2.

TABLE 2

| Sample | Thickness (mm) | CLO | CLO/Thickness |
|---|---|---|---|
| 1 | 4.22 | 1.82 | 0.43 |
| 2 | 4.16 | 1.75 | 0.42 |
| 3 | 4.07 | 1.64 | 0.40 |
| 4 | 4.01 | 1.47 | 0.37 |
| 5 | 3.10 | 1.45 | 0.47 |
| 6 | 4.55 | 1.61 | 0.35 |
| 7 | 4.60 | 1.61 | 0.35 |

The results clearly show that the laminates of this invention are superior in insulation ability to those commercially available. The desired range of CLO for the laminate of the invention is between 1.12 and 1.82, while the desired insulating range of this laminate is between 0.29 and 0.47 CLO/mm. An insulating range for this invention between 0.35 and 0.40 for CLO/mm is desirable.

As will be appreciated by those skilled in the art, changes and variations to the invention are considered to be within the ability of those skilled in the art. Examples of such changes are contained in the patents identified above, each of which is incorporated herein by reference in its entirety to the extent it is consistent with this specification. Such changes and variations are intended by the inventors to be within the scope of the invention.

What is claimed is:

1) An elastic thermal insulating wrap comprising an insulating layer having a thickness between about 1 and 2 mm and a basis weight basis weight between 40 and 100 gsm, an airflow impeding layer having a thickness of less than 0.5 mm, and elastic strands interposed therebetween, bonded together to produce said wrap.

2) The wrap of claim 1 wherein said insulating layer is made from a material selected from the group consisting of tuft-textured coform, non-textured coform, bonded-carded webs, tuft-textured airlaid, non-textured airlaid and bicomponent fiber layers.

3) The wrap of claim 1 wherein said insulating layer is made from a mixture of fibers of polyolefin and pulp.

4) The wrap of claim 2 wherein said insulating layer further comprises an active agent selected from the group consisting of odor, skin health and perspiration absorption.

5) The wrap of claim 3 wherein said polyolefin fibers are selected from the group of consisting of fiber of polyethylene, polypropylene, polybutylene and copolymers, blends, and conjugates thereof.

6) The wrap of claim 3 wherein said polyolefin and pulp are in a weight ratio of between 30/70 and 70/30.

7) The wrap of claim 3 wherein said polyolefin and pulp are in a weight ratio of between 40/60 and 60/40.

8) The wrap of claim 2 wherein said airflow impeding layer is selected from the group consisting of meltblown fabrics, films, spunbond fabrics and laminates thereof.

9) The wrap of claim 8 wherein said airflow impeding layer includes at least one spunbond layer made from bicomponent fibers.

10) The wrap of claim 8 wherein said airflow impeding layer comprises a spunbond layer on an outermost side to provide abrasion resistance.

11) The wrap of claim 1 wherein said airflow impeding layer has a Frazier permeability between 50 and 125 cubic feet per minute per square foot.

12) The wrap of claim 1 wherein said airflow impeding layer has a Frazier permeability between 75 and 100 cubic feet per minute per square foot.

13) The wrap of claim 1 wherein said elastic strands are arranged in a substantially parallel manner.

14) The wrap of claim 13 wherein said elastic strands are made from LYCRA® polymer.

15) The wrap of claim 14 having between 2 and 64 elastic strands per cm of width.

16) The wrap of claim 15 having about 4 strands per cm of width.

17) The wrap of claim 1 wherein said layers are bonded by a material selected from the group consisting of a hot melt adhesive and tacky meltblown fibers.

18) An elastic insulating wrap comprising an insulating layer having a thickness between about 1 and 2 mm and a basis weight basis weight between 40 and 100 gsm, made from a coform material having a weight ratio of polyolefin meltblown fibers and pulp of between about 40/60 and 60/40 and a insulating value of at least 0.3 CLO/mm, an airflow impeding layer made from meltblown polyolefin and having a thickness of less than 0.4 mm, and elastic strands in an amount of between 2 to 64 strands per cm of width therebetween.

19) The wrap of claim 18 further comprising an adhesive between said layers in an amount between 2 and 10 gsm.

20) The wrap of claim 18 wherein said airflow impeding layer has a Frazier permeability between 75 and 100 cubic feet per minute per square foot.

21) An elastic thermal wrap comprising:
a insulating layer having a thickness between about 1 and 2 mm and a basis weight basis weight between 40 and 100 gsm, made from a coform material having a weight ratio of polypropylene meltblown fibers and debonded pulp of between about 30/70 and 70/30, wherein said insulating layer has an insulating value of at least 0.3 CLO/mm;
about 4 elastic strands per cm of width, bonded to said insulating layer using an adhesive at an add-on rate of about 5 gsm, and;
an airflow impeding meltblown polypropylene layer adhesively bonded to said elastic strands and insulating layer and having a thickness of about 0.3 mm and a Frazier permeability of less than 100 cubic feet per minute per square foot.

22) The wrap of claim 21 having an original length which is stretchable and elongatable by at least about 50 percent upon application of an elongation force and will return to within 5 percent of said original length upon release of said elongation force.

23) A method of making an elastic thermal wrap comprising the steps of providing an insulating layer, joining to said insulating layer elastic strands in an amount between 2 to 64 strands per cm of width by spraying adhesive onto said insulating layer while said strands are stretched, adding an airflow impeding layer adjacent said strands, passing the layers, adhesive and strands through a nip to produce a laminate, and passing the laminate through a winder.

24) The method of claim 23 wherein said laminate has a stretching ratio of at least 1.

25) The method of claim 23 wherein said laminate has a stretching ratio of at least 3.
